(19) United States
(12) Patent Application Publication
(10) Pub. No.: US 2002/0078405 A1
(43) Pub. Date: Jun. 20, 2002

(54) Apparatus and method for selling a memory device

(75) Inventor: Takanori Tomioka, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/842,912

(22) Filed: Apr. 27, 2001

(30) Foreign Application Priority Data
Dec. 14, 2000 (JP) 2000-379810(P)

(51) Int. Cl. G06F 11/00

(52) U.S. Cl. 714/42

(57) ABSTRACT

A memory device selling apparatus stores an analytical result of a defective detail in a memory device including fail bits as a result of a test performed in a final test apparatus into a database as memory device information. A customer transmits an acceptable condition of a memory device defective from a customer terminal to the memory device selling apparatus. The memory device selling apparatus searches memory devices fitting the requirement of the customer, creates a combination of the memory devices, and transmits the results thereof to the customer terminal. Thus, the memory device selling apparatus can sell a memory device, even though the device includes a fail bit, without any inconvenience on the customer.

### BACKGROUND OF THE INVENTION

1. Field of the Invention

The present invention relates to an apparatus and a method for selling a memory device, and more particularly, to a memory device selling apparatus connectable to a customer terminal via a network, and a memory device selling method.

2. Description of the Background Art

Conventionally, when a memory device manufacturing maker sells a memory device to a customer, the maker conducts a final test on the memory device before shipment and sells the memory device in which all bits are normally operated in the final test.

Therefore, the memory device manufacturing maker expends enormous efforts to manufacture the memory device satisfying such a condition. Further, if the existence of fail bits, even only a few bits, is found in the final test, the memory device is discarded as a defective. This has made it difficult for the memory device manufacturing maker to reduce the manufacturing cost of the memory device or to expand the production of the memory device.

However, if the maker sold the memory device for which a failure of a few bits were found, it is conceivable that no consumer would purchase such a memory device even at a reduced sales price, concerning possible inconvenience by the memory device.

### SUMMARY OF THE INVENTION

It is an object of the present invention to provide an apparatus and a method for selling a memory device, enabling a memory device manufacturing maker to sell a memory device without any inconvenience on a customer even though the memory device includes a fail bit, and enabling the customer to purchase the memory device at a low price and to use the same without inconvenience.

A memory device selling method according to the present invention using a memory device selling apparatus connectable to a customer terminal via a network, includes the steps of saving memory device information of an analytical result of a memory device performance, and searching the memory device information that has been saved based on a search condition transmitted from the customer terminal to transmit a searched result to the customer terminal.

This allows the customer to check the analytical result of a purchased memory device, and to purchase a desired memory device by thus checking the analytical result before purchasing the memory device.

Preferably, the step of saving saves an analytical result of a defective detail in the memory device as the memory device information.

This allows the customer to search a memory device which has no harm in using even though the memory device has a defective.

More preferably, the search condition is an identifier applied per memory device.

This allows the customer to check the analytical result in performance for each memory device.

More preferably, the search condition is a defective level indicating a degree of a defective detail in the memory device.

This allows the customer to purchase a memory device after searching for a memory device of a defective level acceptable in using.

More preferably, the step of saving saves a direct current value of a memory device as the memory device information, and the step of searching further requests, as the search condition, inputting of the number of memory devices desired by a customer for purchase and a tolerance of a total current value of the memory device, creates a combination of memory devices satisfying the search condition using the memory device information that has been saved, and transmits a result of the combination.

This allows the customer to search and purchase the combination of memory devices, in which the total current value of the memory devices to be purchased satisfies the current value desired by a customer, even if the combination includes a memory device not satisfying a standard current value.

The present invention enables recording of product information for each memory device such that a customer can purchase a memory device based on the information. Therefore, a memory device selling system and a memory device selling method can be provided, enabling sales of the memory device without inconvenience on the customer even if the memory device includes a fail bit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an entire configuration of a memory device selling system according to the fist embodiment of the present invention;

FIG. 2 is a flow chart illustrating operations of the memory device selling system shown in FIG. 1;

FIG. 3 shows an example of a menu screen displayed in step S102 in FIG. 2;

FIG. 4 shows an example of a screen displayed after clicking of an icon 203 in FIG. 3;

FIG. 5 shows an example of a screen displayed in step S104 in FIG. 2;

FIG. 6 shows an example of a screen displayed after clicking of an icon 201 in FIG. 3;

FIG. 7 is a flow chart illustrating operations of a memory device selling system according to the second embodiment of the present invention;

FIG. 8 shows an example of a menu screen displayed in step S102 in FIG. 7;

FIG. 9 shows an example of a screen displayed when a search condition is input on the screen shown in FIG. 8; and

FIG. 10 shows an example of a menu screen displayed in step S104 in FIG. 7.

### DESCRIPTION OF THE PREFERRED EMBODIMENTS

Embodiments of the present invention will be described below in detail with reference to the drawings. It is noted that the same or the corresponding portions are denoted by the same reference characters, and the descriptions thereof will not be repeated.

First Embodiment

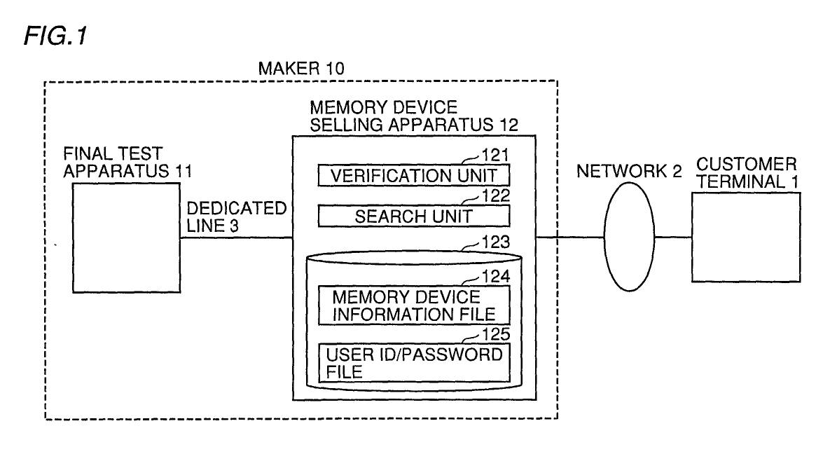

FIG. 1 shows an entire configuration of a memory device selling system according to the first embodiment of the present invention.

Referring to FIG. 1, a memory device selling apparatus 12 installed in a maker 10 is connected via a dedicated line 3 to a final test apparatus 11 also installed in maker 10. Further, memory device selling apparatus 12 is connected to a customer terminal 1 via a network 2.

Memory device selling apparatus 12 includes a verification unit 121, a search unit 122 and a database 123. Database 123 includes a memory device information file 124 storing information about a memory device, and a user ID/password file 125 storing a user ID and a password that are identifiers of a customer connectable to memory device selling apparatus 12.

Verification unit 121 determines whether or not the user ID and the password transmitted from customer terminal 1 match with the ones stored in user ID/password file 125. Further, search unit 122 searches necessary information from memory device information file 124 based on a search condition transmitted from customer terminal 1 to transmit the searched result to customer terminal 1 via network 2.

Final test apparatus 11 performs a final check for a packaged memory device product, to test an all-bit function operation for each memory device, to see if a current value, an access speed or the like satisfies the product specification, and so forth.

Customer terminal 1 is an information processing apparatus which is owned by a customer purchasing a memory device from maker 10 or is provided for the customer by the maker 10.

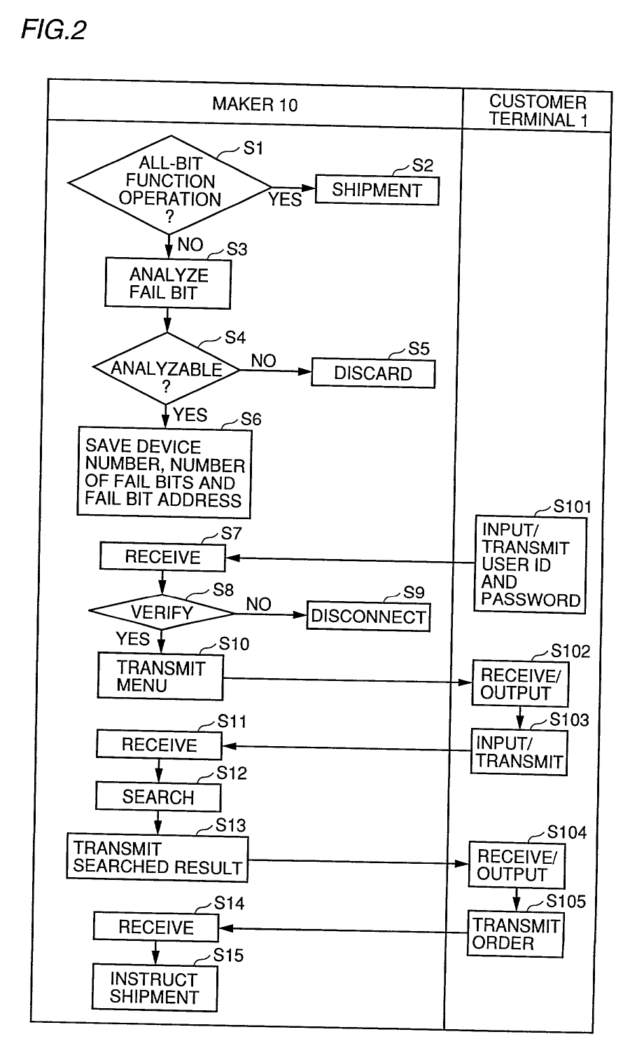

FIG. 2 is a flow chart illustrating operations of the memory device selling system shown in FIG. 1.

Referring to FIG. 2, the packaged memory device is subjected to the final test in final test apparatus 11 before shipment of the product. First, the memory device is inspected to see if the all-bit function operation is performed therein (step S1). If the result of the inspection in step S1 indicates that the all-bit function operation is performed, the memory device is determined as non-defective and is provided, as a product to be shipped, for a customer (step S2). If the result of the test in step S1 indicates that the all-bit function operation is not performed, a fail bit address, which is a defective detail in a memory device not performing the all-bit function operation, is created in final test device 11 (step S3). It is then determined whether or not the number of the fail bits lies within a threshold predetermined by maker 10 (step S4), and if the number of fail bits in the memory device is greater than the threshold, the memory device is discarded as a defective memory device (step S5).

If step S4 determines that the number of fail bits is no greater than the threshold, the memory device is determined as a defective memory device salable to a customer (hereinafter referred to as a semidefective memory device) and is applied with a memory device number serving as an identifier for each memory device. The memory device number may be applied, for example by attaching a magnetic tape or the like storing the memory device number to the semidefective memory device.

Subsequently, the number of fail bits analyzed by the determination in step S4 and the fail bit address thereof are stored, along with the memory device number of the semidefective memory device, into memory device information file 124 in data base 123 of memory device selling apparatus 12 via dedicated line 3 (step S6).

Thus, maker 10 will prepare for shipment of semidefective memory devices without discarding, together with non-defective memory devices.

Subsequently, a case where a customer places an order with maker 10 for a semidefective memory device will be described.

The customer ordering the semidefective memory device from maker 10 inputs a user ID and a password by an input unit (not shown) such as a keyboard, a mouse or the like of customer terminal 1. The input user ID and the password are transmitted to memory device selling apparatus 12 via network 2 (step S101).

Memory device selling apparatus 12 receives the user ID and the password transmitted from customer terminal 1 (step S7), and determines, in verification unit 121, whether or not the user ID and the password transmitted from customer terminal 1 match with the user ID and the password pre-registered in user ID/password file 125 (step S8). If the determined result indicates no matches, customer terminal 1 and memory device selling apparatus 12 are disconnected (step S9).

If the result of verification in step S8 indicates that both the user ID and the password transmitted from customer terminal 1 match with the user ID and the password in user ID/password file 125, the connection between customer terminal 1 and memory device selling apparatus 12 is maintained, and a menu screen is transmitted from memory device selling apparatus 12 to customer terminal 1 (step S10).

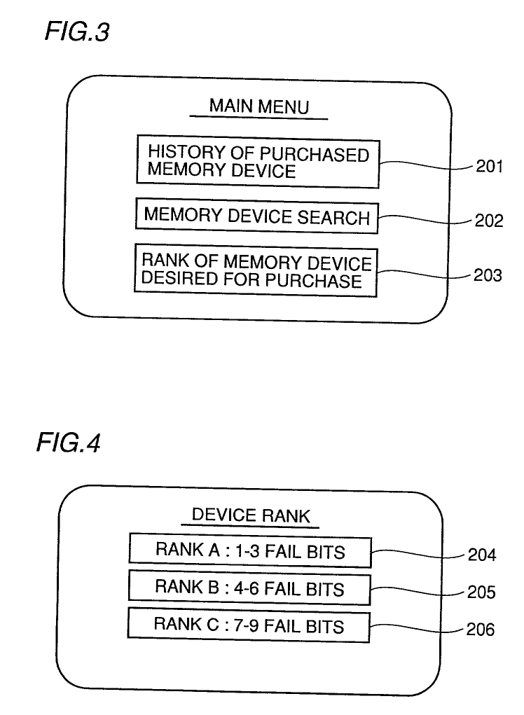

The menu screen is received at customer terminal 1 and is output on a display (not shown) on customer terminal 1 (step S102). An example of the menu screen displayed in step S102 is shown in FIG. 3.

A main menu screen includes a “history of purchased memory devices” icon 201, a “memory device search” icon 202 and a “rank of memory device desired for purchase” icon 203.

If the customer wishes to check the fail bit address before purchase, the customer clicks “rank of memory device desired for purchase” icon 203 by the input unit such as a mouse when the screen shown in FIG. 3 is displayed on customer terminal 1 in step S102. After clicking, the menu screen is changed to a screen shown in FIG. 4.

Here, the customer clicks an icon with a rank satisfying a condition of a memory device he/she wishes to purchase. The customer clicks an icon 204 if he/she wishes to purchase a semidefective memory device having one to three fail bits per memory device (referred to as rank A), clicks an icon 205 if he/she wishes to purchase a semidefective memory device having four to six fail bits per memory device (referred to as rank B), and clicks an icon 206 if he/she wishes to purchase a semidefective memory device having seven to nine fail bits per memory device (referred to as rank C). The search condition is determined by the clicked icon and is transmitted to memory device selling apparatus 12 (step S103).

Memory device selling apparatus 12 receives the search condition transmitted from customer terminal 1 (step S11), and thereafter searches memory device information matched with the search condition from memory device information file 124 by search unit 122 (step S12).

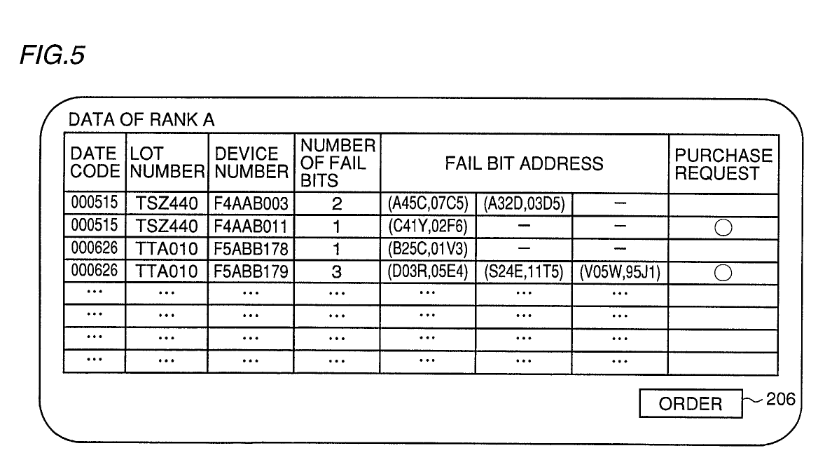

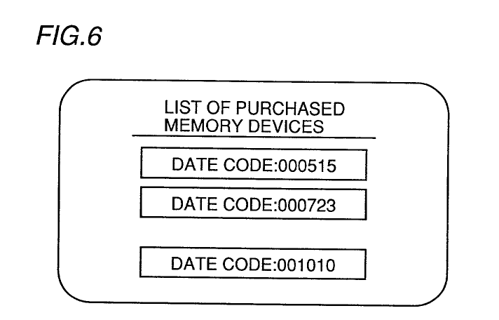

The searched result is transmitted to customer terminal 1 (step S13), which receives the searched result and then outputs the same on a display of customer terminal 1 (step S104). It is noted that the searched result is displayed on the display as a screen as shown in FIG. 5.

In the table on the screen in FIG. 5, a date code indicates the date of manufacture of the memory device, and hence e.g. “000515” means that the date of manufacture is May 15, 2000. Moreover, a lot number is a number applied to a series of memory devices manufactured at the same manufacturing timing. Furthermore, a memory device number is a number applied to each memory device. A fail bit address is recorded in accordance with the number of fail bits.

The customer refers to the searched result in FIG. 5 displayed on the display of customer terminal 1, and if he/she wishes to purchase the product, clicks e.g. the column of purchase request on the table in FIG. 5 to input a mark “O”.

After specifying the memory device desired for purchase, the customer clicks an order icon 206 at the lower right of the screen shown in FIG. 5 to transmit the contents of order to memory device selling apparatus 12.

Memory device selling apparatus 12 receives the contents of order transmitted from customer terminal 1 (step S14), and thereafter gives an instruction for shipment of the ordered semidefective memory device (step S15).

Through the operations described above, the customer can check the fail bit address before purchasing the semidefective memory device.

Further, after purchasing the semidefective memory device from maker 10, the customer may wish to review the history of purchased semidefective memory devices. In such a case, “history of purchased memory devices” icon 201 on the main menu screen shown in FIG. 3 may be clicked to display a list of the semidefective memory devices purchased by the customer in the past by a date code unit. The customer may click the “date code” icon of a desired memory device to review the history for each date code. For example, if the icon indicating “date code: 000515” is clicked, the information about the memory device manufactured on May 15, 2000 is presented of all the semidefective memory devices purchased by the customer. Further, if the customer wishes to review the semidefective memory devices by one unit, he/she may click “memory device search” icon 202 on the main screen shown in FIG. 3 and input a memory device number of the desired semidefective memory device to review the history thereof.

Thus, the maker makes semidefective devices salable, even though they occur, enhancing the product yield. The customer may check the fail bit to select a semidefective memory device which would cause no inconvenience at the time of using and purchase the same at a low price.

Second Embodiment

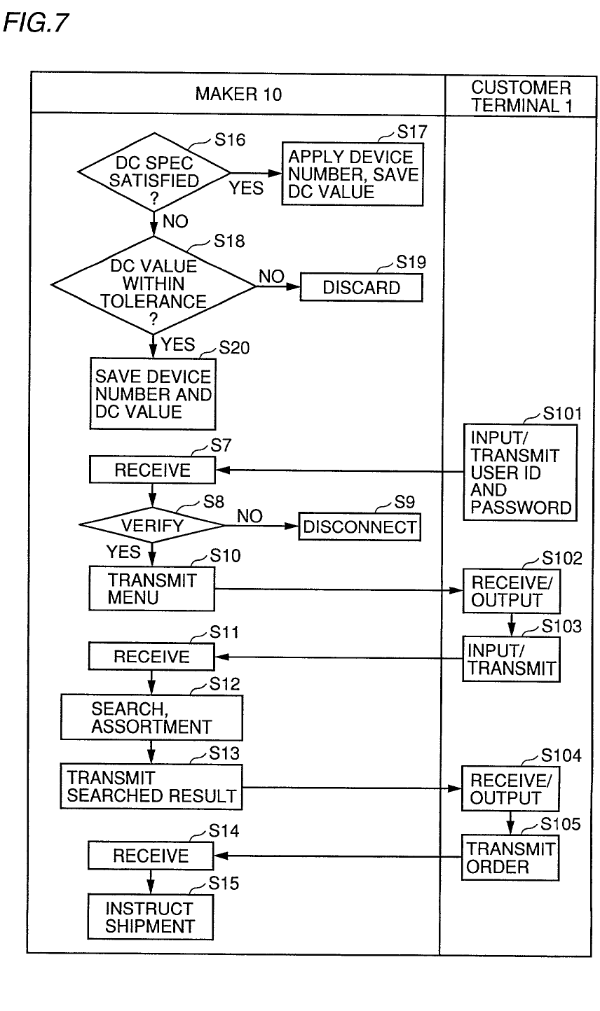

FIG. 7 is a flow chart illustrating operations of a system for selling a defective memory device according to the second embodiment of the present invention.

Referring to FIG. 7, final test apparatus 11 in maker 10 tests to determine if a manufactured memory device satisfies a direct current specification, i.e. DC spec. (step S16). If the memory device satisfies the DC spec, a memory device number which is an identifier per memory device is applied thereto, and thereafter the DC spec value for each memory device number analyzed by the determination in step S16 is saved, together with the memory device number, in memory device information file 124 in database 123 of memory device selling apparatus 12 via dedicated line 3 (step S17).

Whereas, a memory device not satisfying the DC spec would further be determined if the DC value is within a tolerance predefined by maker 10 (step S18). If the DC value of the memory device is out of the tolerance, the device is discarded as a defective memory device. If the DC value of the memory device is within the tolerance, the memory device number and the DC value thereof will be saved into memory device information file 124 in memory device selling apparatus 12, as performed in step S17 (step S20).

As described above, as to the memory devices tested on its DC value in final test apparatus 11, the DC values of both non-defective and semidefective memory devices are saved.

Subsequently, menu transmitting operations by memory device selling apparatus 12 after the customer purchasing the memory device form maker 10 transmits a user ID and so forth from customer terminal 1 to memory device selling apparatus 12 (step S101˜S10) are the same as the ones shown in FIG. 2, so that the descriptions thereof will not be repeated.

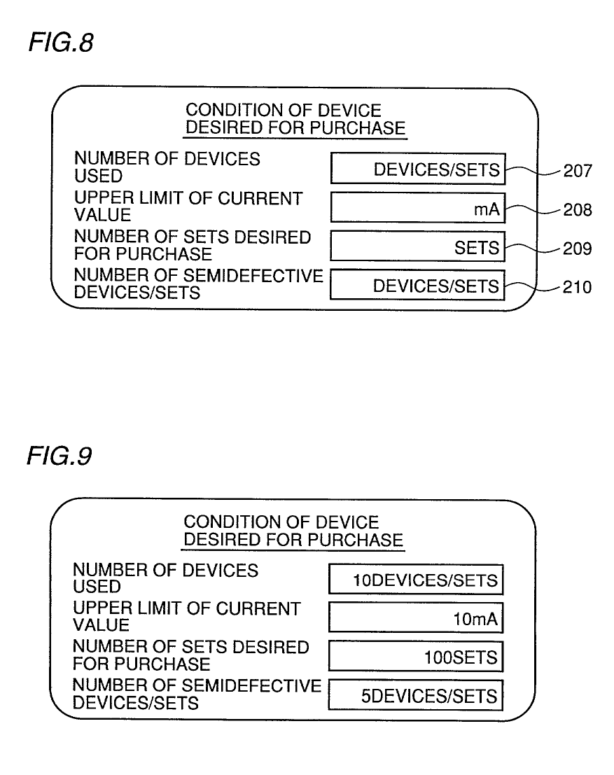

The menu screen transmitted from memory device selling apparatus 12 is received at customer terminal 1 and is output on a display (step S 102). The output menu screen is shown in FIG. 8.

Subsequently, the customer inputs, as a search condition, the number of memory devices used per apparatus set produced by the customer into a box 207, an upper limit of total DC values of the memory devices into a box 208, the number of memory device sets (or the number of memory devices) desired by the customer into a box 209, and the number of semidefective memory devices included per apparatus set produced by the customer into a box 210 (step S103).

The input search condition is received at search unit 122 of memory device selling apparatus 12, and the search for a memory device fulfilling the search condition is executed. In the meantime, search unit 122 also assorts non-defective memory devices and semidefective memory devices and creates a combination thereof, in addition to the search (step S12). The result of the combination is transmitted from memory device selling apparatus 12 to customer terminal 1 (step S13).

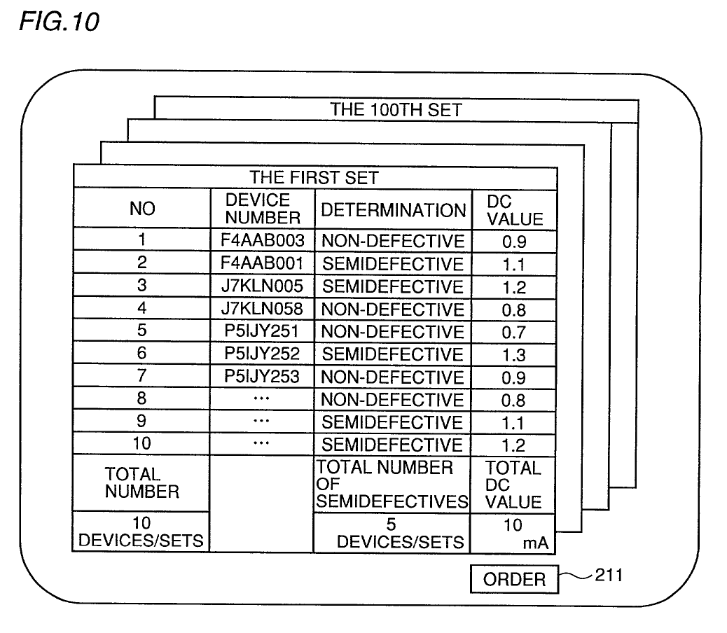

For example, when the customer inputs the search condition shown in FIG. 9, search unit 122 satisfies the upper limit of 10 mA of the DC value desired by the customer, and creates a combination so as to include five semidefective devices per set, before transmitting the results of search/combination shown in FIG. 10 to customer terminal 1.

The transmitted search result is received at customer terminal 1, and is output on a display (step S104). The customer checks the output results of search/combination, and if he/she wishes to order, clicks an “order” icon 211 at the lower right of the screen in FIG. 10 to transmit an order instruction (step S105).

Memory device selling apparatus 12 receives the order instruction (step S14), and thereafter executes an instruction for shipment (step S15).

This allows the customer to purchase semidefective memory devices having the total DC value within the value indicated in the condition, and thus to purchase a memory device satisfying the condition at a low price.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A memory device selling apparatus connectable to a customer terminal via a network, comprising:
a database saving memory device information of an analytical result of a memory device performance; and
a search unit searching said database based on a search condition transmitted from said customer terminal to transmit a searched result to said customer terminal.

2. The memory device selling apparatus according to claim 1, wherein said database saves an analytical result of a defective detail in said memory device as said memory device information.

3. The memory device selling apparatus according to claim 1, wherein said search condition is an identifier applied per said memory device.

4. The memory device selling apparatus according to claim 1, wherein said search condition is a defective level indicating a degree of a defective detail in said memory device.

5. The memory device selling apparatus according to claim 1, wherein
said database saves a direct current value of said memory device as said memory device information, and
said search unit further requests, as said search condition, inputting of the number of memory devices desired by a customer for purchase and a tolerance of a total current value of said memory device, creates a combination of memory devices satisfying said search condition using said database, and transmits a result of the combination.

6. A memory device selling method using a memory device selling apparatus connectable to a customer terminal via a network, comprising the steps of:
saving memory device information of an analytical result of a memory device performance; and
searching said saved memory device information based on a search condition transmitted from said customer terminal to transmit a searched result to said customer terminal.

7. The memory device selling method according to claim 6, wherein said step of saving saves an analytical result of a defective detail in said memory device as said memory device information.

8. The memory device selling method according to claim 6, wherein said search condition is an identifier applied per said memory device.

9. The memory device selling method according to claim 6, wherein said search condition is a defective level indicating a degree of a defective detail in said memory device.

10. The memory device selling method according to claim 6, wherein
said step of saving saves a direct current value of a memory device as said memory device information, and
said step of searching further requests, as said search condition, inputting of the number of memory devices desired by a customer for purchase and a tolerance of a total current value of said memory device, creates a combination of memory devices satisfying said search condition using said memory device information that has been saved, and transmits a result of the combination.
